(19) United States
(12) Patent Application Publication
(10) Pub. No.: US 2014/0253300 A1
(43) Pub. Date: Sep. 11, 2014

(54) REMOTE CONTROL FOR BATTERY-OPERATED HYDRAULIC POWER SYSTEM

(71) Applicant: SPX Hydraulic Technologies, Eygelshoven (NL)

(72) Inventors: Steve Herridge, Swindon (GB); Andreas J. Klemm, Uebach-Palenberg (DE)

(73) Assignee: SPX Hydraulic Technologies, Eygelshoven (NL)

(21) Appl. No.: 14/030,775

(22) Filed: Sep. 18, 2013

(30) Foreign Application Priority Data
Mar. 7, 2013 (EP) 13158234.8

(51) Int. Cl. G08C 19/16; F15B 13/10

(52) U.S. Cl. CPC G08C 19/16; F15B 13/10
USPC 340/12.22

(57) ABSTRACT

A handheld wired remote control unit for battery-operated hydraulic power systems comprises a hydraulic actuator command circuit, a battery level control circuit and an audio/visual operator assistance module. The remote control unit generates a command signal in response to action on the remote control unit by an operator so that the hydraulic actuator can be operated. The battery level control circuit receives a control signal representative of a charge level of a battery that supplies energy to said actuator, and processes it. The audio/visual operator assistance module thus generates an operator assistance event related to the charge level of the battery, such as a flashing light or a buzzing sound. A battery cut-out circuit in the operator assistance module prevents operation of the actuator when the battery level is too low.

### CROSS-REFERENCE TO RELATED APPLICATION

This application claims priority to foreign European Patent Application No. EP 13158234.8, filed on Mar. 7, 2013, the disclosure of which is incorporated by reference in its entirety.

### FIELD OF THE INVENTION

The present invention relates to remote control units for battery-operated hydraulic power systems.

In particular, the present invention relates to remote control units for battery-operated hydraulic power systems for operating hydraulic accessories for vehicles or trailers, such as tail-lift devices, tipping devices or the like.

In addition, the present invention relates to remote-controlled battery-operated hydraulic power systems comprising the above-mentioned remote control units and methods of assisting operators of such systems to gather information on, or to manage, battery levels.

### BACKGROUND OF THE INVENTION

Battery-operated hydraulic power systems are widely used for operating or maneuvering mechanical equipment. These hydraulic power systems offer convenience and versatility, for example in connection with utility vehicles, utility units and utility trailers, such as refuse collection trucks, tipping trailers, tail lift devices, and other hydraulically powered equipment. These battery-operated hydraulic power systems can be linked to or remote from, but connected to or connectable to, a fuelled engine, such as a petrol or diesel engine with connected alternator or dynamo, e.g. for charging the battery, or the battery may be separate from such an energy supply, and connected to or connectable to some other charging means, such as a mains supply.

By means of being battery-operated, the hydraulic power system is not dependent upon mains electricity, or a fuelled engine, for supplying the requisite recharge power during normal use, and thus such mains electricity and/or a fuelled engine can be dispensed with, or located away from, the hydraulic power system during certain periods of use, or between recharges. However, it is often the case that simultaneous recharging is a characteristic feature of the equipment for allowing substantially constant use without significant battery drain. Nevertheless, the engine or mains supply may be disconnected or turned off while the hydraulic power system continues to operate.

It is possible to control such battery-operated hydraulic power systems by means of one or more handheld, wired remote controls, also known in the art as “wander leads”. The operator/user can locate himself in a beneficial position, such as behind but spaced from the equipment, or in an appropriate position for having a good line of sight for optimal operational control. This position, however, can be spaced from the vehicle, unit or trailer, whereupon the remote control becomes his sole means of interaction with (or control of) the actuator or actuators of such systems.

In a typical battery-operated hydraulic power system, at least one battery supplies energy in the form of direct current to one or more hydraulic pumps or actuators, as well as to other electrical accessories of the vehicle, unit or trailer, such as lights, alarms, ventilators, etc. . . . While no recharging unit, such as a fuelled engine driving an alternator or dynamo, or a mains supply, is connected to that system, or if that recharging unit's charging current is insufficient to exceed the drain, the level of charge of the battery will decrease through usage of the power system. As a result, it is important to recharge the battery either simultaneously, or in adequately frequent intervals, to maintain operability. However, if the battery becomes deeply discharged, e.g. while disconnected from a recharging unit, significant vehicle/unit/trailer downtime potentially ensues. This could be because the battery can be severely damaged by the deep discharge, e.g. if the battery's charge is substantially completely used up without adequate recharge, whereupon the battery might need replacement, or a lengthy recharge cycle, or since the vehicle/unit/trailer cannot have its fuelled engine restarted for recommencing a charge cycle due to inadequate power being present to drive the starter motor of the vehicle/unit/trailer, thus requiring alternative recharging means to be sourced.

Modern vehicles incorporate battery recharge units which can be optimally controlled for providing optimised recharge performance. However, even such controls may not allow a restoration of the charge on a deeply discharged battery. There is therefore a need to prevent deep discharge of a battery.

RIPCA (www.ripca.com) offers for sale a device called “Batterywatch”. This is an electronic device that displays battery condition status on a red-amber-green LED display panel. It can also provide an audible alarm for low battery voltages. Devices such as the Batterywatch can be mounted onto vehicles equipped with battery-operated hydraulic power systems to monitor the battery status. Audible alarms, however, can easily be missed when operating a battery-operated power system due to other noises surrounding the vehicles/units/trailers. Furthermore, the LED display panel might not be in the line of sight of the operator, since he would instead be in an optimal operations-watching position. The operator may therefore fail to detect a low battery charge status, even when the vehicle/unit/trailer is fitted with such a Batterywatch system. The operator is thus still at risk of failing to stop operations in time to recharge the battery, with a consequential risk of an undesirably deep discharge of the battery, and thus the above-mentioned vehicle downtime.

Battery-operated accessories with a higher power drain, or that can incapacitate a vehicle/unit/trailer if not allowed to complete an operations cycle, such as hydraulic tail-lift devices and other tipping/lifting devices, clearly exacerbate the above-mentioned problems since these accessories may be operated frequently in any given day, e.g. tens or hundreds of cycles per day, each cycle lasting for a prolonged time period during which the engine of the vehicle/unit/trailer may not be recharging the battery, and these operations may be distant from a mains supply, or any other form of recharging unit, whereupon a discharged battery can become a significant nuisance risk. After all, this can lead to a situation where the remaining electrical charge in the battery is insufficient to complete the operation, such as the dropping of a tipped trailer or the lifting and closing or a tail-lift device. The vehicle can thus become immobilised, either due to the unfinished procedure, or for the impossibility to re-start the engine.

The present invention seeks to mitigate or resolve one or more of the above-mentioned problems. The invention is mainly (but not only) related to applications involving the above-mentioned kinds of hydraulic accessories. In the present application, we conventionally refer to these kinds of hydraulic accessories as “medium duty” hydraulic accessories, intending this to extend to accessories designed for load handling, but yet being capable of being satisfactorily operated by battery power alone. Other applications for the present invention, however, include non-hydraulic power systems, including motor driven systems such as screw-thread systems, and pneumatic systems.

### SUMMARY OF THE INVENTION

According to the present invention there is provided a remote control unit for controlling a battery-operated power system, the remote control unit comprising:

an actuator command circuit configured for generating a command signal for commanding operation of an actuator of the battery-operated power system;

a battery level control circuit configured for receiving a control signal representing a battery level of a battery, or of a group of batteries, of the battery-operated power system; and

an operator assistance module, operably connected to said battery level control circuit, said operator assistance module configured for generating at least one operator assistance event, detectable or otherwise perceivable by the operator, directly or indirectly.

The operator assistance event is associated to said battery level and can thus inform an operator on the status of the battery, or help the operator to manage the battery level.

According to a preferred aspect of the present invention, there is provided a remote control unit for controlling a battery-operated hydraulic power system, the remote control unit comprising:

a hydraulic actuator command circuit configured for generating a command signal for commanding operation of an hydraulic actuator of the battery-operated hydraulic power system;

a battery level control circuit configured for receiving a control signal representing a battery level of a battery, or of a group of batteries, of the battery-operated hydraulic power system; and

an operator assistance module, operably connected to said battery level control circuit, said operator assistance module configured for generating at least one operator assistance event, detectable or otherwise perceivable by the operator, directly or indirectly.

The remote control unit can be configured for being held by hand by the operator.

The remote control unit can be part of a wired assembly connected to the power system. Such assemblies are sometimes referred to as “wander leads”.

Preferably, said actuator command circuit is configured for generating the command signal in response to an action exerted by an operator on the remote control unit, so that the operator is required actively to perform said action if he wishes to operate the actuator. The operator can thus decide whether to perform said action if the operator assistance event has been triggered.

Preferably, said action is a pressure exerted by said operator on a button of the remote control unit.

Said battery level control circuit can be configured for:

a) logically processing said control signal; and

b) generating at least one assistance signal, each assistance signal being generated in response to a respective predetermined logical criterion. Said predetermined logical criterion can simply be a threshold criterion. For example, for a nominally 12 volt vehicle battery, if battery level falls lower than 11 Volts, generate assistance signal, or if battery level lower than 10 Volts, generate assistance signal or if battery level lower than 9 Volts, generate assistance signal, or for each of these generate a suitably escalated assistance signal, with lowering voltages triggering an increasingly escalated assistance signal.

Preferably an assistance signal is triggered, raised or generated if the measured (or represented) voltage falls below that battery's nominal voltage rating by a predetermined increment, i.e. to an incrementally reduced voltage level, such as a 1V drop, or a 2V drop, or a 3V drop, again with preferred escalation of the assistance signal upon a crossing of multiple such incremental drops. For a 24V battery, that singular increment is preferably either a 1V drop or a 2V drop or a 3V drop. For a 12V battery, that singular increment is preferably either a 1V drop or a 2V drop. For a 6V battery, that increment might be a half volt drop or a 1V drop. Whole numbers, fractional drops or complex numbers may be the predetermined incremental drops used to determine whether to generate a or the assistance signal.

Preferably, said at least one predetermined logic criterion is a criterion related to a condition of low charge of said battery so that the operator can protect the battery from damage arising from deep discharge.

Preferably, said battery level control circuit is configured for generating at least two assistance signals, from at least two respective predetermined logical criteria, said predetermined logical criteria being different between each other, e.g. “if battery level lower than 10 Volts, generate first assistance signal” and “if battery level lower than 9 Volts, generate second assistance signal”. This is an example of an escalating assistance signal.

Preferably, said operator assistance module is configured for receiving said at least one operator assistance signal and, in response to said at least one operator assistance signal, generating said at least one operator assistance event, so that the operator assistance event is directly associated with the generation of the operator assistance signal and thus is directly related to a predetermined battery level.

Preferably, said operator assistance module is configured for receiving two or more operator assistance signals and, in response to each of said two or more operator assistance signals, generating two or more respective operator assistance events, said operator assistance events being different between each other, so that the operator can receive more information relating to the battery level, or the battery level can be more closely monitored.

Preferably, said operator assistance module comprises a visual indicator, which preferably comprises an LED, and said operator assistance module is adapted such that said operator assistance event or one of said operator assistance events is a light emitted from said visual indicator. The visual indicator may be a light emitting diode (LED), or a visual display screen, such as a LCD, or both. Other forms of visual indicator are also possible. Visual indicators often can readily draw the attention of the operator, and LEDs are very economical to run. As such, the operator assistance event might be an illumination or flashing of the LED or screen, or of a symbol on the screen.

Additionally or alternatively, said operator assistance module may comprise a sound generation means, which preferably comprises a buzzer or a speaker, and said operator assistance module is adapted such that said operator assistance event or one of said operator assistance events is a sound emitted from said sound generation means. Audio indicators also readily draw the attention of the operator, and can thus suitably complement or replace any visual indicator.

Preferably, as an alternative to the visual/audio indicator, or in addition thereto, the operator assistance module comprises a vibration generation device such that the handset might vibrate, much like a mobile telephone. Vibrational indicators also readily draw the attention of the operator, and can thus suitably complement or replace any visual or audible indicator.

The operator assistance means may comprise a battery cut-out circuit configured for inhibiting generation of the command signal or otherwise cutting out or inhibiting operation of the battery. In such a manner, the operator is prevented from causing deep battery discharge and vehicle downtime because he is not able to operate the hydraulic accessories past a certain battery charge limit.

In some embodiments, the battery cut-out circuit is only activated at a later stage, i.e. after the attention of the operator has first been drawn to the condition of the battery by the visual and/or audio means, e.g. only if the operator persists in operating the system after audio or visual warnings to stop. A relay can be provided as a part of the cut-out circuit to provide the cut-out function. Alternatively, a battery cut-out device activated by said battery cut-out circuit may be provided externally of the remote control unit, e.g. close or next to the battery.

In these embodiments, said operator assistance module may be configured such that one of said operator assistance events is a battery cut-out signal produced by said battery cut-out circuit. Said actuator command circuit may be further configured for receiving said battery cut-out signal and for cutting out operation of said actuator of said battery-operated power system in response to said battery cut-out signal. Alternatively, said battery cut-out signal can activate an external battery cut-out device connected to the battery and located, e.g. next or close to said battery. Battery deep discharge can thus be prevented, or at least the associated risk can be proactively managed.

Preferably, said operator assistance module is configured such that one of said two or more operator assistance events is light that can be emitted from said visual indicator and another of said two or more operator assistance events is the battery cut-out signal that can be produced by said battery cut-out circuit.

Preferably, the operator assistance module is further configured such that said light is emitted in connection with a first battery level, and the battery cut-out signal is produced in connection with a second, lower battery level, so that the operator is first warned of a potential risk of battery discharge, and the battery is then cut out if the operator attempts to further drain the battery.

Alternatively, said operator assistance module is configured such that one of said two or more operator assistance events is sound that can be emitted from said sound generation means and another of said two or more operator assistance events is the battery cut-out signal that can be produced by said battery cut-out circuit.

Preferably, the operator assistance module is further configured such that the sound is emitted in connection with a first battery level, and the battery cut-out signal is produced in connection with a second, lower battery level, so that the operator is first warned of a potential risk of battery discharge, and the battery is then cut out if the operator attempts to further drain the battery.

Alternatively, said operator assistance module is configured such that one of said two or more operator assistance events is vibration that can be generated by said vibration generation means and another of said two or more operator assistance events is the battery cut-out signal that can be produced by said battery cut-out circuit.

Preferably, the operator assistance module is further configured such that said vibration is generated in connection with a first battery level, and the battery cut-out signal is produced in connection with a second, lower battery level, so that the operator is first warned of a potential risk of battery discharge, and the battery is then cut out if the operator attempts to further drain the battery.

In very preferred embodiments, the operator assistance module is configured for generating three operator assistance events, a first of said three operator assistance events being light that can be emitted from said visual indicator; a second being sound that can be emitted from said sound generation means or vibration that can be generated by said vibration generation means; and a third being the battery cut-out signal that can be produced by said battery cut-out circuit. Thus the operator can more closely monitor the evolution of the battery level during discharge.

Preferably, the operator assistance module is further configured such that said first operator assistance event is generated in association with a first battery level, said second operator assistance event is generated in association with a second, lower battery level, and said third operator assistance event is associated with a third, yet lower battery level. Thus the operator is first warned of a potential risk of battery discharge by means of a visual signal, then warned of an increased such risk by means of an aural or vibrational signal and finally the battery is cut out if the operator attempts to further drain the battery.

According to a further aspect of the present invention, there is provided a remote-controlled and battery-operated hydraulic power system comprising at least a battery, a hydraulic actuator and a remote control unit according to any one of the preceding clauses. Said system can be provided e.g. on a vehicle or trailer.

According to a further aspect of the invention, there is provided a method for assisting an operator of a battery-operated power system to gather information on, or to manage, battery level in connection with said system, said method comprising the steps of:

providing a remote-controlled and battery-operated power system of the above mentioned type, i.e. in accordance with the invention;

receiving in or on the remote control unit a control signal representative of the battery level of said at least one battery;

logically processing said control signal in the remote control unit according to a predetermined logic criterion;

generating in or on the remote control unit an operator assistance event associated with said battery level.

Preferably said predetermined criterion is a criterion related to a condition of low charge of said battery.

Preferably the method further comprises the step of cutting out generation of said command signal in the remote control unit or alternatively activating an external battery cut-out device provided e.g. close to the battery. This may be a first event, or it may be an event subsequent to one or more of an audible, visual or tactile event.

Further preferred features are set out below and in the appended claims.

### BRIEF DESCRIPTION OF THE DRAWINGS

FIGS. 1a and 1b are illustrations of an intelligent battery control device known from the prior art;

FIG. 2 is a circuit diagram representing parts of a remote control unit according to an embodiment of the present invention and relating to a tipping vehicle;

FIG. 3 is an illustration of a remote control unit according to a first embodiment of the present invention;

FIG. 4 is an illustration of a remote control unit according to another embodiment of the invention;

FIG. 5 is an illustration of a remote control unit according to yet another embodiment of the invention;

FIG. 6 is an illustration of a vehicle incorporating an hydraulic power system in accordance with the present invention;

FIG. 7 is an illustration of the remote control unit of FIG. 5 with a back cover removed to reveal the internal wiring;

FIG. 8 is an illustration of the printed circuit board (PCB) of the remote control unit of FIGS. 5 and 7;

FIG. 9 is a schematic connection diagram of the connection between the remote control unit of FIGS. 5 and 7 and a generic battery-operated hydraulic power system;

FIG. 10 is a perspective view of a prior art battery-operated hydraulic power system suitable for operation using the remote control unit of FIGS. 5, 7 and 8, the power system being mounted on the chassis of a tipping trailer;

FIG. 11 is a detail view of parts of the system of FIG. 10;

FIG. 12 is an “in-use” representation of a prior art tipping trailer on which is mounted a battery-operated hydraulic power system suitable for operation using the remote control unit of FIGS. 5, 7 and 8;

FIG. 13 is a perspective view of the tipping trailer of FIG. 12 revealing parts of the battery-operated hydraulic power system; and

FIG. 14 is a perspective view of another prior art tipping vehicle equipped with a battery-operated hydraulic power system suitable for adaptation to be in accordance with the present invention.

### DETAILED DESCRIPTION

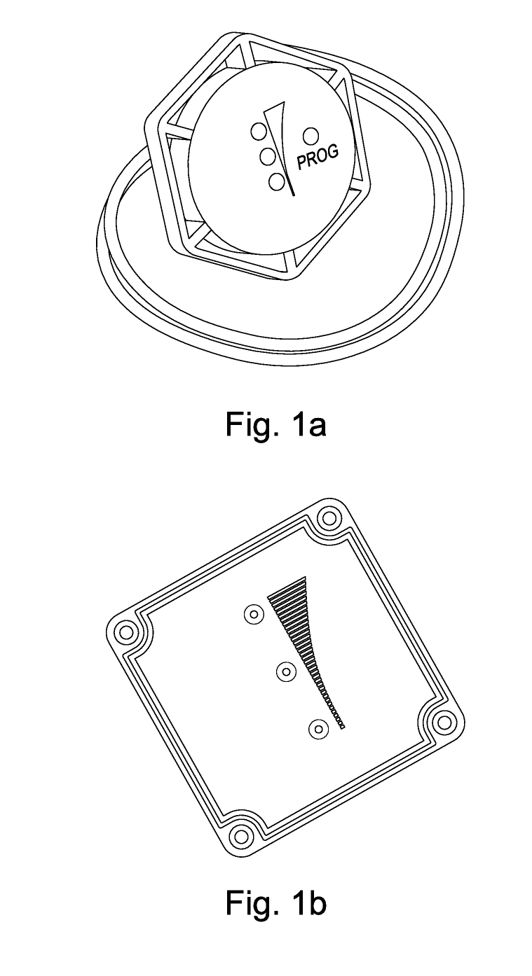

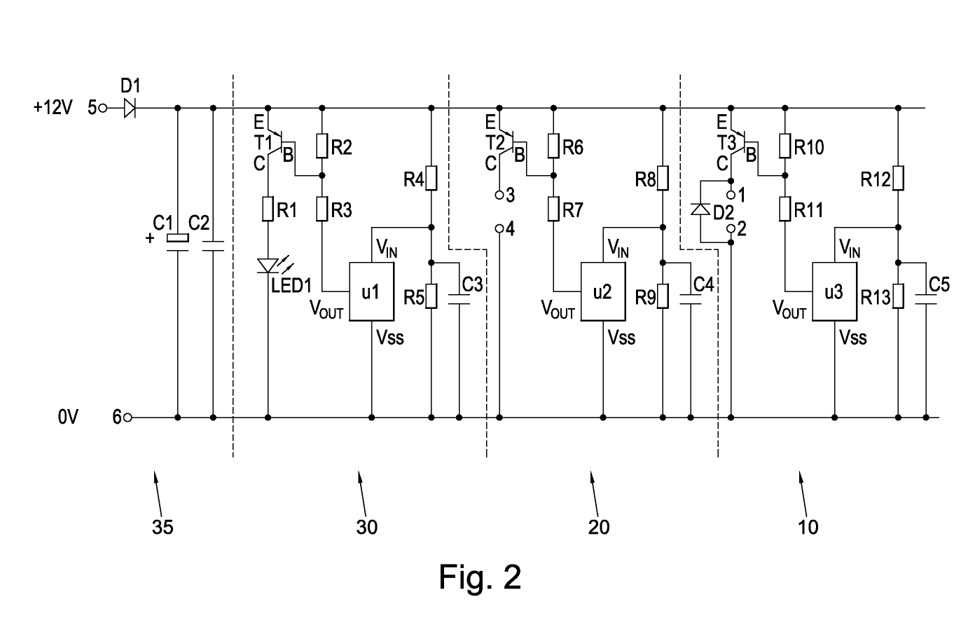

FIG. 1a shows the core part of a Batterywatch device, as referred to above in the background section. FIG. 1b shows a front plate designed for being assembled on the core part of FIG. 1a. FIGS. 1a and 1b have been included in the drawings purely to help understand the invention. As mentioned, the Batterywatch is an electronic device that displays battery condition status on a red-amber-green LED display panel. The display is clearly visible on FIG. 1b. The Batterywatch is designed for connection to a battery via the wires shown in FIG. 1a. Battery charge levels are different for different batteries and the Batterywatch device is programmable so that different thresholds can be set for different batteries. The red-amber-green LED display at a glance informs the operator as to whether the charge level of the battery is, respectively, low, medium or high.

The Batterywatch can also be programmed to provide an audible alarm for low battery voltages.

The present invention is based on the concept of providing the input and output functionalities of the Batterywatch (the input functionality being that which allows the Batterywatch to detect the battery charge or voltage, and the output functionality being that which allows the Batterywatch to inform or warn the user as to the battery status) on a remote control unit for controlling and operating battery-operated power systems, and particularly battery-operated hydraulic power systems.

Reference will now be made in detail to the embodiments of the invention, and vehicles for adaptation to be within the scope of the present invention, as illustrated in FIGS. 2 to 14 of the drawings. The examples are provided to assist with the explanation of the invention, rather than to limit the scope of the invention. It will be apparent to those of ordinary skill in the art that various modifications and variations can be made to the present invention without departing from the scope of the invention as defined by the appended claims, and the above statements of invention. As such, it is intended that the present invention cover such modifications and variations, and their equivalents.

Repeat use of reference symbols in the present specification and drawings is intended to represent the same or analogous features or elements, also across different embodiments.

A list of reference signs used herein is given at the end of the specific embodiments, immediately prior to the claims.

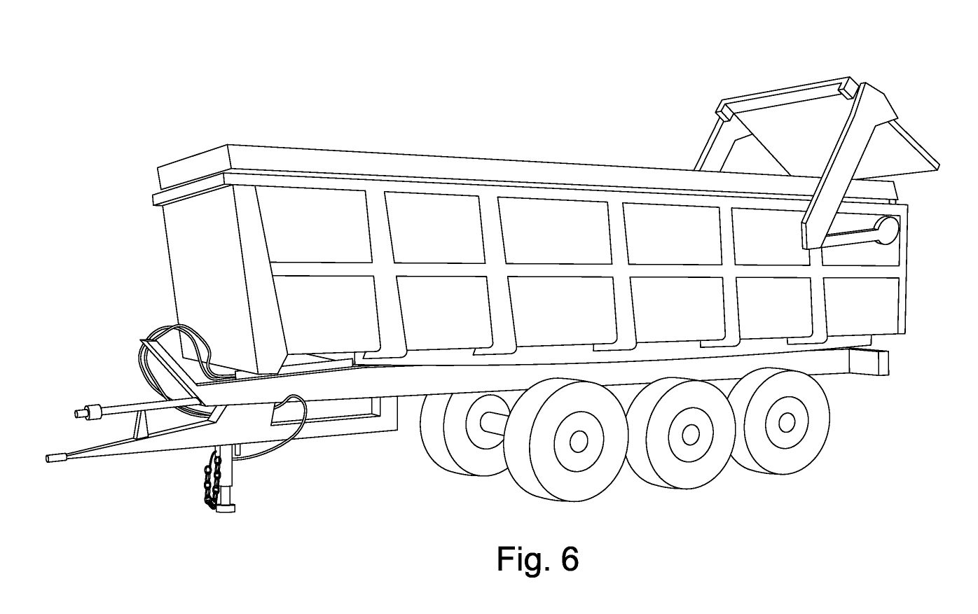

Battery-operated power systems can be provided with many different types of actuator. A common form of actuator is a hydraulic actuator driven by a pump. The pump sources hydraulic fluid from a tank, and pumps the hydraulic fluid towards a hydraulic actuator that can thus be extended. Reverse operation of the pump retracts the actuator. The pump is battery operated. A tipping trailer incorporating more than one hydraulic actuator is shown in FIG. 6—there is one or more hydraulic actuator for the tail lift—for opening and closing the rear of the trailer, and one or more actuator for the bed of the trailer—for lifting and lowering the bed for tipping contents of the trailer out through the rear thereof, when open as shown.

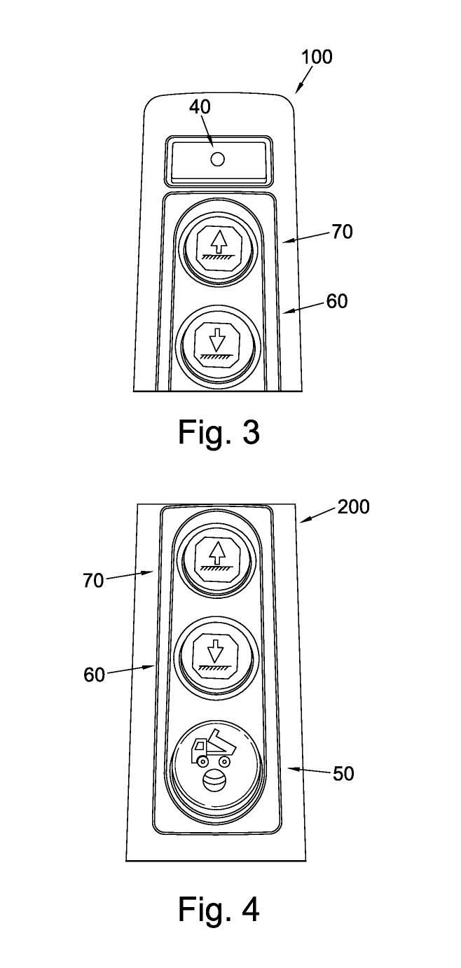

Separate control units, or separate control buttons on a common control unit, can be provided for each actuator, or more usually for each actuator function, such as tipping the bed trailer and lowering the trailer (see e.g. the bottom button 50 in FIG. 4, which may be a rocker switch for that purpose, or alternatively the top two buttons in that figure, with the top button 70 being for lifting, i.e. tipping the trailer and the middle 60 button being for lowering it). Other button symbolisation might be preferred—the remote controls in FIGS. 3 to 5 are generic for this specification.

It will be understood that battery-operated power systems comprise at least one battery and at least one actuator operatively connected to the battery so that power for extending or retracting the actuator is provided by the battery.

FIG. 2 shows a sample circuit diagram for printed circuit boards for installation into remote controls units according to the invention. A command circuit 10 for extending an actuator is shown on the right hand side of FIG. 2 and comprises contacts 1, 2 for a suitable hydraulic actuator switch, such as switch 70 (e.g. in the controller shown in FIG. 3 or FIG. 4 or FIG. 5) for extending the actuator. It also comprises a transistor T3, a diode D2, resistors R10, R11, R12 and R13, a capacitor C5 and an operating unit u3, all connected as shown in the Figure.

Upon depression of the actuator switch 70 the operating unit u3 generates a command signal representing an instruction to extend the actuator. The command signal is transmitted to the pump controls which cause the pump to pump the hydraulic fluid to extend the actuator. As a consequence, the contents of the truck are emptied through tipping of the bed (or the tail lift is raised).

The transmission of command signal may be direct, e.g. through a wired system, or it may be indirect. For example, if wirelessly transmitted, it might first be passed to a transmitting circuit (not shown since the illustration is a wired arrangement with a direct transmission along the wire, but if present it would be part of the remote control unit) which routes it toward a receiving circuit (not part of the remote control) located remotely with respect to the remote control, which routing could be through a wireless transmission. The receiving circuit will then be responsible for responding to the signal as appropriate so that the actuator of the tipping truck is operated to extend the actuator.

A command circuit 20 for retracting the actuator is also shown in FIG. 2 and comprises contacts 3, 4 for a suitable hydraulic actuator switch, such as switch 60 (e.g. in the controller shown in FIG. 3 or FIG. 4 or FIG. 5). It is instead for retracting the actuator. The circuit 20 also comprises a transistor T2, resistors R6, R7, R8 and R9, a capacitor C4 and an operating unit u2, connected as shown in the Figure.

On depression of the actuator switch 60 the operating unit u2 generates a command signal representing an instruction to retract the actuator. The command signal is passed to the pump controls which cause the pump to operate in a reverse manner i.e. to retract the actuator. The actuator of the tipping truck is operated to retract, and the tipping operation is terminated (or the tail gate is closed).

As before, this might be direct or indirect, or wired or wireless.

A battery level control circuit 30 is also shown in FIG. 2 and it comprises a transistor T1, resistors R1, R2, R3, R4 and R5, a capacitor C3, an operating unit u1 and a light emitting diode LED1, connected as shown in the Figure. The battery level control circuit 30 is configured for receiving a battery control or “monitoring” signal representative of a charge level of a battery (i.e. the battery for supplying energy to said battery-operated hydraulic power system) for processing said monitoring signal and for generating an operator assistance signal in response to at least one predetermined criterion. The above requirements are fulfilled via operating unit u1 which will thus comprise a programmable logic controller for processing the control signal. In the embodiment illustrated in FIG. 2, operating unit u1 is programmed such that the operator assistance signal is generated if, and only if, the monitoring signal corresponds to a battery charge level lower than a predetermined threshold value. The battery level monitoring signal, represented in FIG. 2 schematically by source and ground voltages S and G, comes from a transmitting element not shown in the drawings and not part of the remote control.

In this example, the operator assistance signal simply activates the light emitting diode LED1 so that the operator assistance light 40 (see FIG. 3) is switched on. This event allows the operator to be informed of a “battery low” scenario.

FIG. 2 also shows a current/voltage input and smoothing or conditioning circuit 35 comprising a polarized capacitor C1, a further capacitor C2 and a diode D1. The nominal 12V supply represents the battery level control signal, and it varies according to the battery charge level. Thus, when fully charged, it may be 13V, whereas when largely depleted it may be 10V or lower, e.g. 9V or 8V, etc.

FIG. 3 shows a remote control 100 which incorporates a printed circuit board according to the circuit diagram of FIG. 2. The operator is visually informed in relation to a battery low status via operator assistance light 40. It has two actuator control buttons.

FIG. 4 shows an alternative embodiment of a remote control 200 which incorporates a printed circuit board similar to that of FIG. 2 but different in that the operator assistance signal activates an operator assistance buzzer 50 instead of an operator assistance light 40, as was the case for FIG. 3. It has three buttons, the top two being for controlling one actuator function (raising and lowering something, e.g. a tailgate) and the third button being a tip control button for controlling the tipping function. For example, it might be a rocker switch, with pressing the top half making the tipping action go upwards, and the bottom half being a downwards action. Alternatively it could be a press and hold button for cycling through a tip and lower cycle. It may also have other arrangements.

The buzzer emits its sound through the hole in the lower button 50, thus being directed at the operator, and potentially being felt as well as heard by the operator. It may alternatively be arranged elsewhere, i.e. it may be separate from the button(s).

A vibration module may instead or additionally be provided in either handset, or in the next handset.

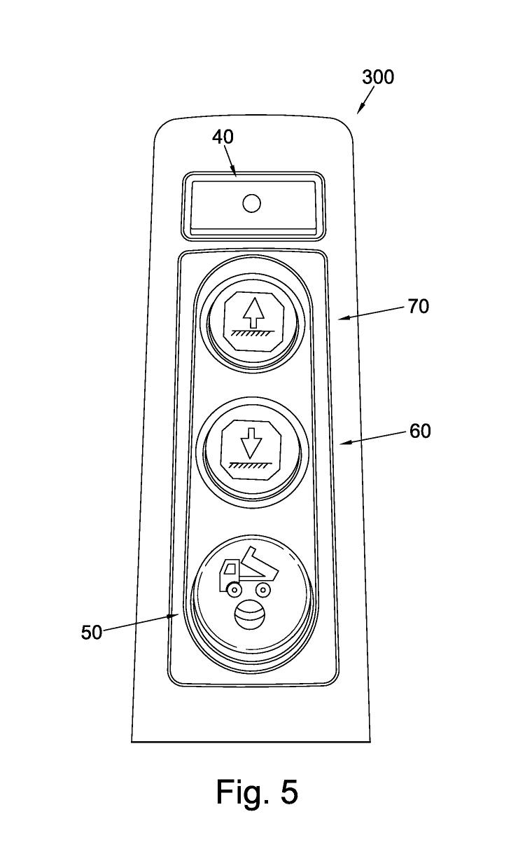

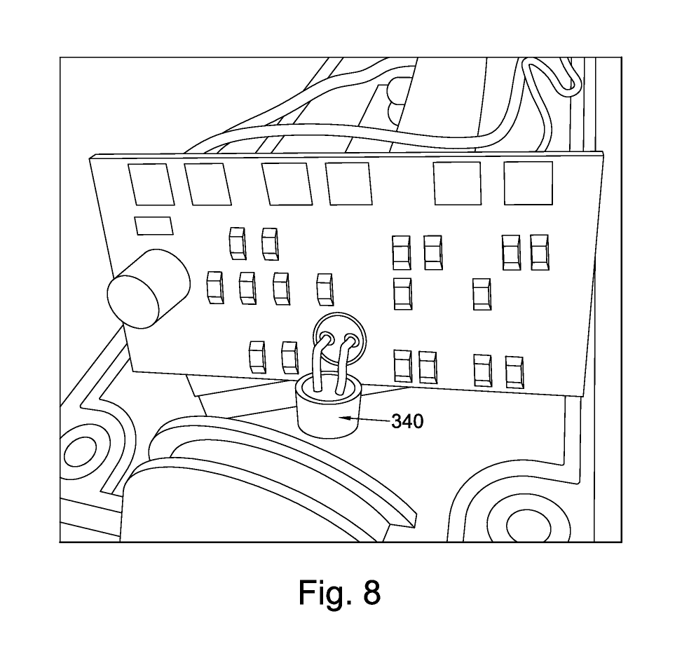

FIG. 5 is a more advanced embodiment of a remote control 300 according to the invention and it includes both an operator assistance light and an operator assistance buzzer. It further includes a cut-out function which is designed to inhibit generation of a command signal (for instructing an operation with an actuator) even if any the actuator switches 60, 70 on the remote control are depressed. Deep battery discharge can thus be avoided through the user ignoring or failing to note the warning signal events. In the embodiment shown in FIG. 8, the cut-out function is designed to operate an external battery cut-out switch which is not part of the remote control unit. As shown in the schematic diagram of FIG. 8, such external battery cut out switch is positioned between the battery and the pump so as to cut out the battery if required.

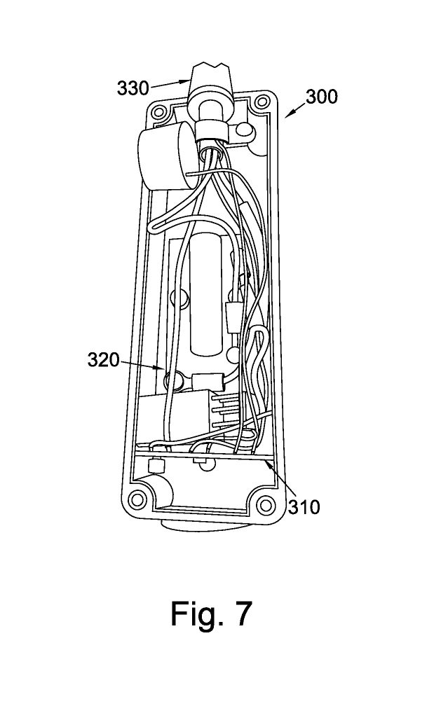

FIG. 7 shows the remote control unit 300 of FIG. 5 with a back cover thereof removed to reveal the internal circuitry and wiring. A printed circuit board (PCB) 310 implements the circuit schematically illustrated in FIG. 2. Notably, a battery cut-out lead 320 departs from the PCB 310 and leaves the remote control unit 300 together with other cables. The cables, as a bundle, are routed out through an external cable 330 that connects the remote control unit 300 with the battery-operated hydraulic power system.

FIG. 8 shows in more detail the PCB 310 of FIG. 7. In particular it can be noted that the PCB comprises an LED light 340, in accordance with the circuit shown in FIG. 2. The LED light 340 provides the operator assistance light 40 of FIG. 5.

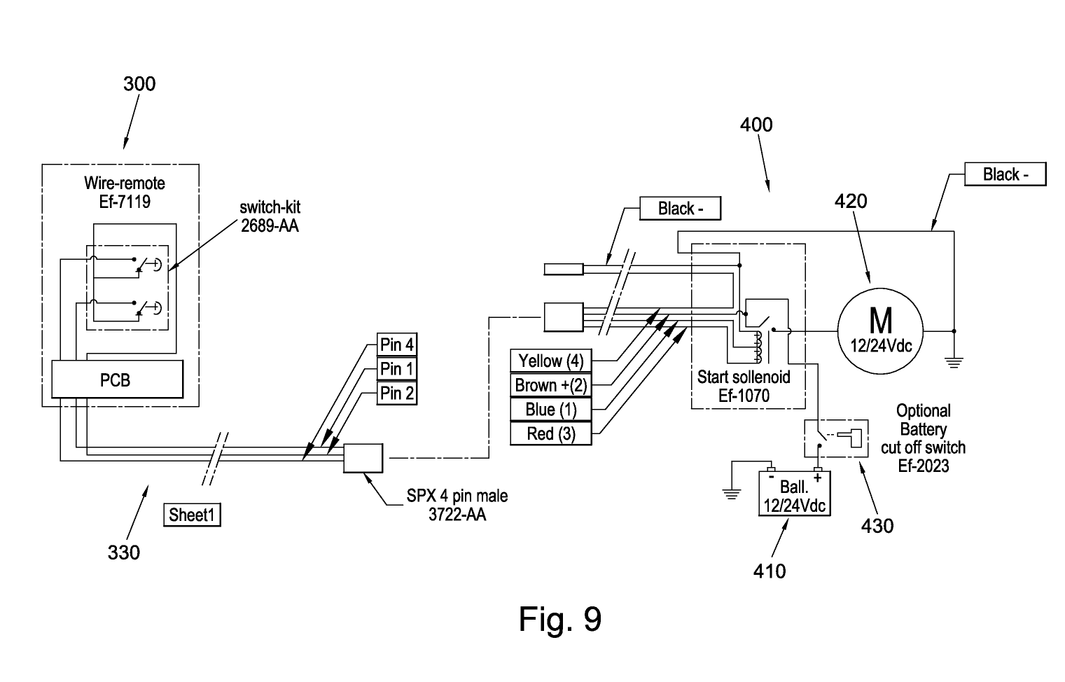

FIG. 9 shows schematically the connection between the remote control unit 300 of FIGS. 5, 7 and 8, via its lead 330, to a generic battery-operated hydraulic power system 400. Said power system 400 comprises a battery 410, a battery cut-out switch 430 and a battery-operated pump 420. The battery cut-out switch is operably connected to said battery 410 and is located between the battery 410 and the pump 420 so as to cut-out (i.e. operably disconnect) the battery 410 from the pump 420, if required.

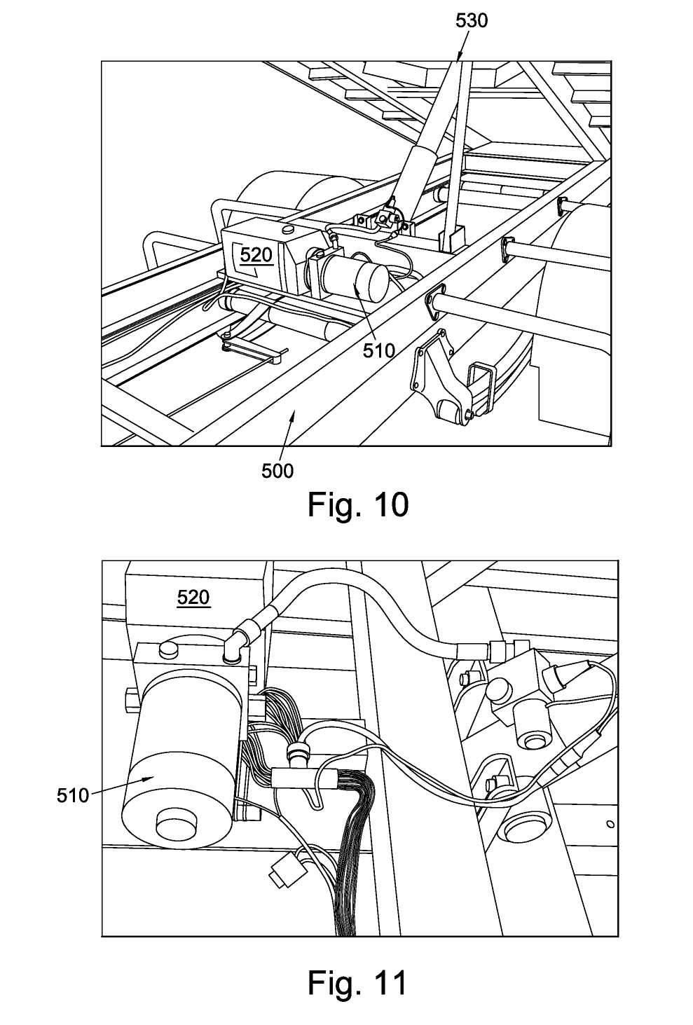

FIG. 10 shows a chassis 500 of a tipping trailer accommodating a battery-operated hydraulic power system comprising a pump 510, a tank 520 for hydraulic liquid and an actuator 530 for lifting and lowering the bed of the tipping trailer.

FIG. 11 shows certain parts of the hydraulic power system seen in FIG. 10 in more detail, namely the pump 510 and the tank 520 for the hydraulic liquid. Various cables and wires are also illustrated—these belong to the electrical and electronic control system. The above described control circuitry can be utilised with this type of hydraulic power system.

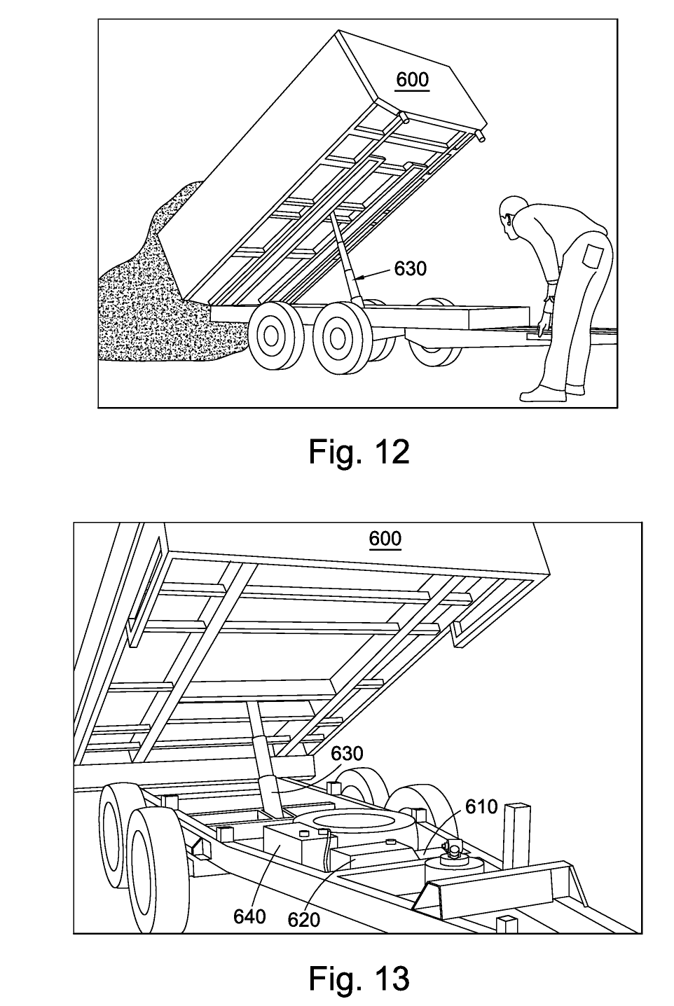

FIG. 12 shows an operator operating a tipping trailer 600 via of a remote control unit. That control unit can be adapted to include the above described control circuitry or it can be replaced with the control unit 300 of FIGS. 5, 7 and 8, thus adapting the system to be in accordance with the present invention. Then, if the battery level goes below a first predetermined charge level the operator will be able to see a light emitted from the operator assistance light 40 of the remote control unit 300. Should the operator continue to use the hydraulic system, and should this result in further battery discharge, the remote control unit 300 would then emit a buzzing sound from the operator assistance buzzer 50 to warn the operator that a second threshold battery level, lower than the first level, has now been reached. The operator has the option to stop using the hydraulic system, or to return the actuator to a safe position if necessary and then proceed to recharge the battery. If the operator continues to use the hydraulic system, thereby draining further the battery beyond a third predetermined level of battery charge, the battery cut-out functionality would then cut out the battery supply. This is to prevent full battery discharge and any consequent damage to the battery.

FIG. 13 shows the tipping trailer of FIG. 12 so as to reveal the location of the main components of the battery-operated hydraulic power system, which includes a pump 610, a tank 620 for hydraulic liquid, a battery 640 and a hydraulic actuator 630.

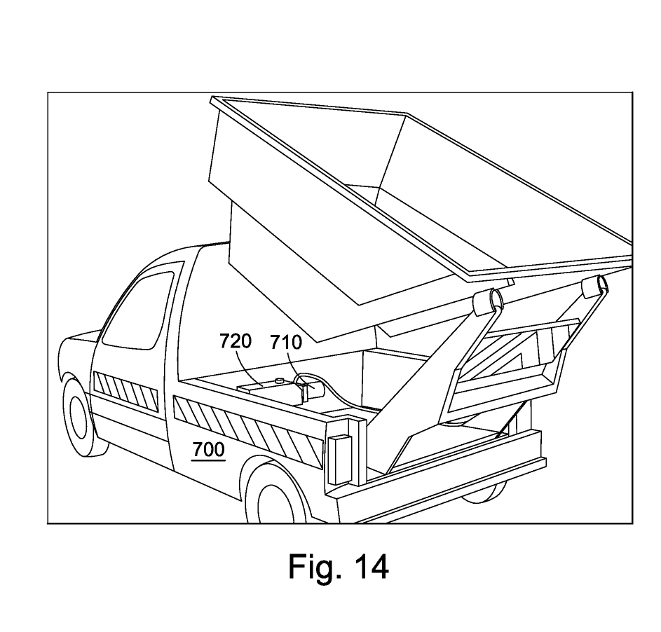

FIG. 14 show a tipping vehicle 700 equipped with a battery operated hydraulic power system. FIG. 14 shows the location on the vehicle 700 of the pump 710 and the hydraulic liquid tank 720. This vehicle can also be adapted to include the above-described control circuitry or control units so as to bring it into accordance with the present invention.

We have therefore described above a circuit for implementing a remote control unit in accordance with the invention and remote control units 100, 200 and 300 in accordance with the invention. These achieve, in addition to or as a consequence of the features discussed above, a remote control unit for battery-operated hydraulic power systems comprising an actuator command circuit, a battery level control circuit and an operator assistance module capable of generating operator assistance events of the visual/aural/tactile type, or in the form of a battery cut-out event.

The remote control generates a command signal in response to action on the remote control from an operator for operating the actuator of the battery-operated hydraulic power system.

The battery level control circuit receives a monitoring signal representative of a charge level of the battery for supplying energy to said battery-operated hydraulic power system, and then it processes it and it may cause the operator assistance module to generate an operator assistance event related to the charge level of the battery such as a flashing light, a buzzing sound, a vibration or a cut-out signal for inhibiting or cutting out operation of the battery and/or actuator.

Any combination of the above listed events is also contemplated. Preferred combinations include: generation of a light in connection with a first, higher battery level and subsequently generation of a battery cut-out event in connection with a second, lower battery level; and generation of a light in connection with a first, higher battery level and subsequently generation of a sound or vibration in connection with a second, intermediate battery level and generation of a subsequent battery cut-out event in connection with a third, lower battery level.

It will be clear that remote controls in accordance with the present invention serve to address one or more problem associated with the prior art referred to above. A remote control in accordance with the invention enables an operator to gather information on, or to manage, battery power efficiently in connection with battery-operated hydraulic power systems. This is especially important when such systems are provided to operate medium duty hydraulic accessories such as tail-lift or tipping hydraulic accessories.

### LIST OF REFERENCE SIGNS

S source voltage
G reference voltage (ground)
D1 first diode
C1 first, polarised capacitor
C2 second capacitor
T1 first transistor
E transistor emitter
B transistor base
c transistor collector
R1 first resistor
LED1 light emitting diode
R2, R3, R4 and R5 respectively: second, third, fourth and fifth resistors
C3 third capacitor
Vin Input voltage
Vout Output voltage
Vss reference voltage (ground)
u1 first operating unit
u2 second operating unit
u3 third operating unit
T2 second transistor
T3 third transistor
R6 sixth resistor
R7 seventh resistor
R8 eight resistor
R9 ninth resistor
C4 fourth capacitor
3 first contact for hydraulic retraction switch
4 second contact for hydraulic retraction switch
1 first contact for hydraulic extension switch
2 second contact for hydraulic extension switch
D2 second diode
R10 tenth resistor
R11 11^{th} resistor
R12 12^{th} resistor
R13 13^{th} resistor
C5 fifth capacitor
LED1 light emitting diode
10 hydraulic actuator command circuit for extending the actuator
20 hydraulic actuator command circuit for retracting the actuator
30 battery level control circuit
40 operator assistance light
50 tipping button integral with operator assistance buzzer
60 hydraulic actuator switch for retracting the actuator
70 hydraulic actuator switch for extending the actuator
100 remote control according to a first embodiment
200 remote control according to a second embodiment
300 remote control according to a third embodiment
310 PCB
320 battery cut out lead
330 external cable or wander lead
340 LED light
400 battery-operated hydraulic power system
410 battery
420 pump
430 battery cut-out switch
500 chassis of tipping trailer
510 pump
520 tank
530 actuator
600 tipping trailer
610 pump
620 tank
630 actuator
640 battery
700 tipping vehicle
710 pump
720 tank

What is claimed is:

1. A remote control unit for controlling a battery-operated hydraulic power system, the remote control unit comprising:
a hydraulic actuator command circuit configured for generating a command signal for commanding operation of an hydraulic actuator of the battery-operated hydraulic power system;
a battery level control circuit configured for receiving a control signal representing a battery level of a battery, or of a group of batteries, of the battery-operated hydraulic power system; and
an operator assistance module, operably connected to said battery level control circuit, said operator assistance module configured for generating at least one operator assistance event, said operator assistance event being associated to said battery level.

2. A remote control unit according to claim 1, wherein said battery level control circuit is configured for:
a) logically processing said control signal; and
b) generating at least one assistance signal, each assistance signal being generated in response to a respective predetermined logical criterion.

3. A remote control unit according to claim 2, wherein said battery level control circuit is configured for generating at least two assistance signals, from at least two respective predetermined logical criteria, said predetermined logical criteria being different between each other.

4. A remote control unit according to claim 2, wherein said operator assistance module is configured for receiving said at least one operator assistance signal and, in response to said at least one operator assistance signal, generating said at least one operator assistance event.

5. A remote control unit according to claim 4, wherein said operator assistance module is configured for receiving two or more operator assistance signals and, in response to each of said two or more operator assistance signals, generating two or more respective operator assistance events, said operator assistance events being different between each other.

6. A remote control unit according to claim 1, wherein said operator assistance module comprises a visual indicator, which preferably comprises an LED, wherein said operator assistance module is adapted such that said operator assistance event or one of said operator assistance events is a light emitted from said visual indicator.

7. A remote control unit according to claim 1, wherein said operator assistance module comprises a sound generation means, which preferably comprises a buzzer, wherein said operator assistance module is adapted such that said operator assistance event or one of said operator assistance events is a sound emitted from said sound generation means.

8. A remote control unit according to claim 1, wherein said operator assistance module comprises a vibration generation means, which preferably comprises a shaker, wherein said operator assistance module is adapted such that said operator assistance event or one of said operator assistance events is a vibration generated by said vibration generation means.

9. A remote control unit according to claim 1, wherein said operator assistance module comprises a battery cut-out circuit, which circuit preferably comprises a battery cut-out switch or relay.

10. A remote control unit according to claim 9, wherein said operator assistance module is configured such that one of said operator assistance events is generation of a battery cut-out signal produced by said battery cut-out circuit.

11. A remote control unit according to claim 5, wherein:
a) said operator assistance module comprises a visual indicator, which preferably comprises an LED,
b) said operator assistance module is adapted such that said operator assistance event or one of said operator assistance events is a light emitted from said visual indicator;
c) said operator assistance module comprises a battery cut-out circuit, which circuit preferably comprises a battery cut-out switch or relay;
d) said operator assistance module is configured such that one of said operator assistance events is generation of a battery cut-out signal produced by said battery cut-out circuit; and
e) said operator assistance module is configured such that one of said two or more operator assistance events is respectively:
light that can be emitted from said visual indicator;
sound that can be emitted from said sound generation means; or
vibration that can be emitted from said vibration generation means, and
another of said two or more operator assistance events is the battery cut-out signal that can be produced by said battery cut-out circuit.

12. A remote control unit according to claim 11, wherein the operator assistance module is further configured such that the light is emitted in connection with a first battery level, and the battery cut-out signal is produced in connection with a second, lower battery level.

13. A remote control unit according to claim 5, wherein
a) said operator assistance module comprises a sound generation means, which preferably comprises a buzzer,
b) said operator assistance module is adapted such that said operator assistance event or one of said operator assistance events is a sound emitted from said sound generation means;
c) said operator assistance module comprises a battery cut-out circuit, which circuit preferably comprises a battery cut-out switch or relay;
d) said operator assistance module is configured such that one of said operator assistance events is generation of a battery cut-out signal produced by said battery cut-out circuit; and
e) said operator assistance module is configured such that one of said two or more operator assistance events is respectively:
light that can be emitted from said visual indicator;
sound that can be emitted from said sound generation means; or
vibration that can be emitted from said vibration generation means, and
another of said two or more operator assistance events is the battery cut-out signal that can be produced by said battery cut-out circuit.

14. A remote control unit according to claim 13, wherein the operator assistance module is further configured such that the sound is emitted in connection with a first battery level, and the battery cut-out signal is produced in connection with a second, lower battery level.

15. A remote control unit according to claim 5, wherein:
a) said operator assistance module comprises a vibration generation means, which preferably comprises a shaker;
b) said operator assistance module is adapted such that said operator assistance event or one of said operator assistance events is a vibration generated by said vibration generation means;
c) said operator assistance module comprises a battery cut-out circuit, which circuit preferably comprises a battery cut-out switch or relay;
d) said operator assistance module is configured such that one of said operator assistance events is generation of a battery cut-out signal produced by said battery cut-out circuit; and
e) said operator assistance module is configured such that one of said two or more operator assistance events is respectively:
light that can be emitted from said visual indicator;
sound that can be emitted from said sound generation means; or
vibration that can be emitted from said vibration generation means, and
another of said two or more operator assistance events is the battery cut-out signal that can be produced by said battery cut-out circuit.

16. A remote control unit according to claim 15 wherein the operator assistance module is further configured such that the vibration is generated in connection with a first battery level, and the battery cut-out signal is produced in connection with a second, lower battery level.

17. A remote control unit according to claim 1, wherein the operator assistance module is configured for generating three operator assistance events, a first of said three operator assistance events being light that can be emitted from a visual indicator; a second being sound that can be emitted from a sound generation means or vibration that can be generated by a vibration generation means; and a third being a battery cut-out signal that can be produced by a battery cut-out circuit.

18. A remote control unit according to claim 17, wherein the operator assistance module is further configured such that said first operator assistance event is generated in association with a first battery level, said second operator assistance event is generated in association with a second, lower battery level, and said third operator assistance event is associated with a third, yet lower battery level.

19. A remote-controlled and battery-operated hydraulic power system comprising at least a battery, a hydraulic actuator and a remote control unit or wander lead for controlling a battery-operated hydraulic power system, the remote control unit or wander lead comprising:
a hydraulic actuator command circuit configured for generating a command signal for commanding operation of an hydraulic actuator of the battery-operated hydraulic power system;
a battery level control circuit configured for receiving a control signal representing a battery level of a battery, or of a group of batteries, of the battery-operated hydraulic power system; and
an operator assistance module, operably connected to said battery level control circuit, said operator assistance module configured for generating at least one operator assistance event, said operator assistance event being associated to said battery level.

20. A method for assisting an operator of a battery-operated hydraulic power system to gather information on, or to manage, battery levels, said method comprising the steps of:
providing a remote-controlled and battery-operated hydraulic power system comprising at least a battery, a hydraulic actuator and a remote control unit or wander lead for controlling a battery-operated hydraulic power system, the remote control unit or wander lead comprising:
a hydraulic actuator command circuit configured for generating a command signal for commanding operation of an hydraulic actuator of the battery-operated hydraulic power system;
a battery level control circuit configured for receiving a control signal representing a battery level of a battery, or of a group of batteries, of the battery-operated hydraulic power system; and
an operator assistance module, operably connected to said battery level control circuit, said operator assistance module configured for generating at least one operator assistance event, said operator assistance event being associated to said battery level;
receiving in or on the remote control unit a control signal representative of the battery level of said at least one battery;
logically processing said control signal in the remote control unit; and
generating in or on the remote control unit an operator assistance event associated with said battery level.
